(19) United States
(12) Patent Application Publication
(10) Pub. No.: US 2026/0120197 A1
(43) Pub. Date: Apr. 30, 2026

(54) MONITORING AND NOTIFYING ALERT SERVICES FOR HEALTHCARE PROVIDERS

(71) Applicant: Robin Hood Justice, LLC, Chagrin Falls, OH (US)

(72) Inventor: Benjamin Pfouts, Chagrin Falls, OH (US)

(21) Appl. No.: 19/364,737

(22) Filed: Oct. 21, 2025

Related U.S. Application Data
(60) Provisional application No. 63/711,925, filed on Oct. 25, 2024.

(51) Int. Cl. G06Q 40/08; G06Q 20/10

(52) U.S. Cl. CPC G06Q 40/084; G06Q 20/102

(57) ABSTRACT

In certain aspects, a method includes receiving patient information of a patient including payor information. The method includes determining, based on the payor information, a primary payor and at least one secondary payor. The method includes determining a submission deadline date for each payor that were determined. The method includes transmitting a medical claim to a primary payor device associated with the primary payor. The method includes determining an advance submission date for each secondary payor, and assigning the advance submission date to each secondary payor. The method includes monitoring a healthcare provider device for payment data related to the medical claim. The method includes monitoring each advance submission date previously assigned to each secondary payor. The method includes transmitting, based on determining, from the payment data monitored, that there is a balance amount remaining on the medical claim, a secondary medical claim to a secondary payor device.

### CROSS-REFERENCE TO RELATED APPLICATIONS

The present application claims the benefit of priority under 35 U.S.C. § 119 from U.S. Provisional Patent Application Ser. No. 63/711,925 entitled “Monitoring and Notifying Alert Services for Healthcare Providers,” filed on Oct. 25, 2024, the disclosure of which is hereby incorporated by reference in its entirety for all purposes.

### TECHNICAL FIELD

The present disclosure generally relates to monitoring and notification alert services, and more specifically relates to monitoring and notifying alert services for healthcare providers.

### BACKGROUND

Generally, healthcare providers submit bills for medical services provided to payors as medical claims. While these claims can be submitted through paper form (e.g., CMS 1500 form, UB-92 form), medical claims are more commonly submitted electronically in the HIPAA 837 format to the potential payor or a vendor (such as a clearinghouse) who then submits the medical claim to the potential payor through an electronic data interchange (“EDI”). Further, every payor has a deadline from the time that the service was provided within which medical claims from the provider must be received to be considered for remittance, either through statute or agreement entered into.

Sometimes a patient will have multiple insurance coverages or potential coverages. For example, where a person is injured in a motor vehicle accident, the automobile insurance policy that covered the patient or the vehicle that the patient occupied may contain coverage for the medical service (e.g. medical payment coverage (“Medpay”) or personal injury protection (“PIP”)) that is also covered by the patient's health insurance.

Many providers will opt to submit their bills to the patient's auto insurer initially since these insurers reimburse at better rates than private and public health insurers and due to coordination of benefits provisions in contracts and statutes governing public health insurance. However, medical claims submitted to automobile insurers are often not covered or not covered in full for various reasons (e.g., the available coverage had already been exhausted by other provider claims, the available coverage does not cover the bill in full, or the automobile policy had actually lapsed at the time of the incident). Often times, the provider is not informed of the unfulfilled payment from the automobile insurer in time to then submit their bill to the patient's health insurer (or next available insurer or potential payor in line), or are not made aware of the patient's secondary health insurance at the time of being informed of the unfulfilled remittance from the automobile insurer, thereby resulting in a missed opportunity for payment from the secondary insurer(s). Further, upon being informed or made aware of the unfulfilled payment from the automobile insurer, providers will often attempt to collect payment from the patient directly for their bill, thereby opening themselves up to legal liability and/or ramifications from the centers of Medicaid or Medicare (e.g., revocation as a Medicare or Medicare provider).

The description provided in the background section should not be assumed to be prior art merely because it is mentioned in or associated with the background section. The background section may include information that describes one or more aspects of the subject technology.

### SUMMARY

In particular aspects, the present disclosure provides systems and methods for monitoring for and notifying healthcare providers. For example, the disclosed technology alerts a healthcare provider of a lack of remittance from a primary payor, such as, but not limited to, an automobile insurer, at a time that will allow the healthcare provider to seek remittance from a secondary payor(s) for any remaining balance and/or to electronically submit their medical claim for any remaining balance to the secondary payor in advance of that secondary payor's submission deadline after having not received full remittance from the primary payor.

In certain aspects, a healthcare provider device is configured to receive patient information associated with a patient. In certain aspects, a healthcare provider device is configured to communicate or transmit a payment request (e.g., a claim submission) associated with the patient to a payor device. In certain aspects, a healthcare provider device is configured to alert the healthcare provider associated with the healthcare provider device to submit a non-electronic payment request. In certain other aspects, the healthcare provider device is configured to submit patient information and claim information to a vendor device associated with a vendor, such as, but not limited to, a clearinghouse, who then submits a claim submission to a payor device. For ease of understanding, such a vendor device will be considered the same as a healthcare provider device throughout the disclosure as the present technology operates similarly with respect to a healthcare provider device and a vendor device.

According to certain aspects of the present disclosure, a computer-implemented method for monitoring and notifying a healthcare provider device is provided. The method includes receiving patient information of a patient including payor information. The method includes determining, based on the payor information of the patient information, a primary payor and at least one secondary payor. The method includes determining a submission deadline date for each of the primary payor and the at least one secondary payor that were determined. The method includes transmitting a medical claim, associated with the patient and a healthcare provider, to a primary payor device associated with the primary payor. The method includes determining an advance submission date for each secondary payor determined from the at least one secondary payor. The method includes assigning the advance submission date to each secondary payor. The method includes monitoring a healthcare provider device associated with the healthcare provider for payment data related to the medical claim. The method includes monitoring each advance submission date previously assigned to each secondary payor. The method includes transmitting, based on determining, from the payment data monitored, that there is a balance amount remaining on the medical claim, a secondary medical claim to a secondary payor device associated with the secondary payor on an advance submission date assigned to the secondary payor.

According to other aspects of the present disclosure, a system is provided. The system includes a memory comprising instructions and a processor configured to execute the instructions which, when executed, cause the processor to receive patient information of a patient including payor information. The processor is configured to execute the instructions which, when executed, cause the processor to determine, based on the payor information of the patient information, a primary payor and at least one secondary payor. The processor is configured to execute the instructions which, when executed, cause the processor to determine a submission deadline date for each of the primary payor and the at least one secondary payor that were determined. The processor is configured to execute the instructions which, when executed, cause the processor to transmit a medical claim, associated with the patient and a healthcare provider, to a primary payor device associated with the primary payor. The processor is configured to execute the instructions which, when executed, cause the processor to determine an advance submission date for each secondary payor determined from the at least one secondary payor. The processor is configured to execute the instructions which, when executed, cause the processor to assign each advance submission date to each secondary payor. The processor is configured to execute the instructions which, when executed, cause the processor to monitor a healthcare provider device associated with the healthcare provider for payment data related to the medical claim. The processor is configured to execute the instructions which, when executed, cause the processor to monitor each advance submission date previously assigned to each secondary payor. The processor is configured to execute the instructions which, when executed, cause the processor to transmit, based on determining, from the payment data monitored, that there is a balance amount remaining on the medical claim, a secondary medical claim to a secondary payor device associated with the secondary payor on an advance submission date assigned to the secondary payor.

According to other aspects of the present disclosure, a non-transitory machine-readable storage medium comprising machine-readable instructions for causing one or more processors to execute a method is provided. The method includes receiving patient information of a patient including payor information. The method includes determining, based on the payor information of the patient information, a primary payor and at least one secondary payor. The method includes determining a submission deadline date for each of the primary payor and the at least one secondary payor that were determined. The method includes transmitting a medical claim, associated with the patient and a healthcare provider, to a primary payor device associated with the primary payor. The method includes determining an advance submission date for each secondary payor determined from the at least one secondary payor. The method includes assigning the advance submission date to each secondary payor. The method includes monitoring a healthcare provider device associated with the healthcare provider for payment data related to the medical claim. The method includes monitoring each advance submission date previously assigned to each secondary payor. The method includes transmitting, based on determining, from the payment data monitored, that there is a balance amount remaining on the medical claim, a secondary medical claim to a secondary payor device associated with the secondary payor on an advance submission date assigned to the secondary payor.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. It should be noted that although various aspects may be described herein with reference to corporate, organization, healthcare, retail, or educational settings, these are examples only and are not to be considered limiting. The teachings of the present disclosure may be applied to any mobile device environments, including but not limited to organization environments, home environments, healthcare environments, retail environments, educational environments, corporate environments, and other appropriate environments. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for monitoring and notifying a healthcare provider.

FIG. 2 is a block diagram illustrating the example healthcare provider device, a primary payor device, at least one secondary payor device, coordination service, database, and vendor device from the architecture of FIG. 1 according to certain aspects of the disclosure.

FIG. 3 illustrates an example process for monitoring and notifying a healthcare provider using the healthcare provider device, the primary payor device, the at least one secondary payor device, the coordination service, the vendor service, and, in certain aspects, the database of FIG. 2.

FIGS. 4A and 4B illustrate example processes 400A and 400B, according to certain aspects, using the healthcare provider device, the primary payor device, the at least one secondary payor device, the coordination service, the vendor service, and, in certain aspects, the database of FIG. 2.

FIG. 5 is block diagram illustrating an example computer system with which the example healthcare provider device, a primary payor device, at least one secondary payor device, coordination service, database, and vendor device of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed technology provides systems and methods for alerting a healthcare provider of a lack of remittance from a primary payor, such as, but not limited to, an automobile insurer, at a time that will allow the healthcare provider to seek remittance from a secondary payor(s) for any remaining balance and/or to electronically submit their medical claim for any remaining balance to the secondary payor in advance of that secondary payor's submission deadline after having not received full remittance from the primary payor.

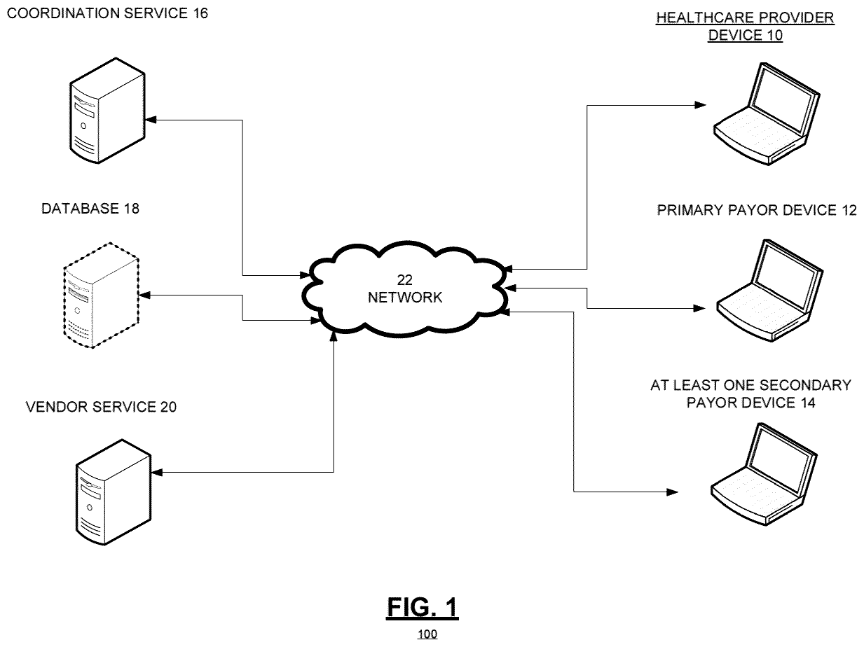

FIG. 1 illustrates an example architecture 100 for monitoring and notifying a healthcare provider device. For example, the architecture 100 includes a healthcare provider device 10, a primary payor device 12, at least one secondary payor device 14, a coordination service 16, optionally, a database 18, and a vendor service 20 all connected over a network 22.

The healthcare provider device 10, to which the primary payor device 12, the at least one secondary payor device 14, the coordination service 16, in certain aspects, the database 18, and the vendor service 20 communicate with over the network 22, can be, for example, a tablet computer, a mobile phone, a mobile computer, a laptop computer, a portable media player, an electronic book (eBook) reader, or any other device having appropriate processor, memory, and communications capabilities. Similarly, the primary payor device 12, to which the healthcare provider device 10, the coordination service 16, and the vendor service 20 communicate with over the network 22, can be, for example, a tablet computer, a mobile phone, a mobile computer, a laptop computer, a portable media player, an electronic book (eBook) reader, or any other device having appropriate processor, memory, and communications capabilities. Similarly, the at least one secondary payor device 14, to which the healthcare provider device 10, the coordination service 16, and the vendor service 20 communicate with over the network 22, can be, for example, a tablet computer, a mobile phone, a mobile computer, a laptop computer, a portable media player, an electronic book (eBook) reader, or any other device having appropriate processor, memory, and communications capabilities.

The coordination service 16 can be any device having an appropriate processor, memory, and communications capability for communicating with the healthcare provider device 10, the primary payor device 12, the at least one secondary payor device 14, the database 18, and the vendor service 20. For purposes of load balancing, the coordination service 16 may include multiple servers.

The database 18 can be any device having an appropriate processor, memory, and communications capability for communicating with the healthcare provider device 10 and the coordination service 16. For purposes of load balancing, the database 18 may include multiple servers.

The vendor service 20 can be any device having an appropriate processor, memory, and communications capability for communicating with the healthcare provider device 10, the primary payor device 12, and the at least one secondary payor device 14. For purposes of load balancing, the vendor service 20 may include multiple servers.

In certain aspects, the coordination service 16, the database 18, and the vendor service 20 can be a cloud computing server of an infrastructure-as-a-service (IaaS) and be able to support a platform-as-a-service (PaaS) and software-as-a-service (SaaS) services.

The network 22 can include, for example, any one or more of a personal area network (PAN), a local area network (LAN), a campus area network (CAN), a metropolitan area network (MAN), a wide area network (WAN), a broadband network (BBN), the Internet, and the like. Further, the network 22 can include, but is not limited to, any one or more of the following network topologies, including a bus network, a star network, a ring network, a mesh network, a star-bus network, tree or hierarchical network, and the like.

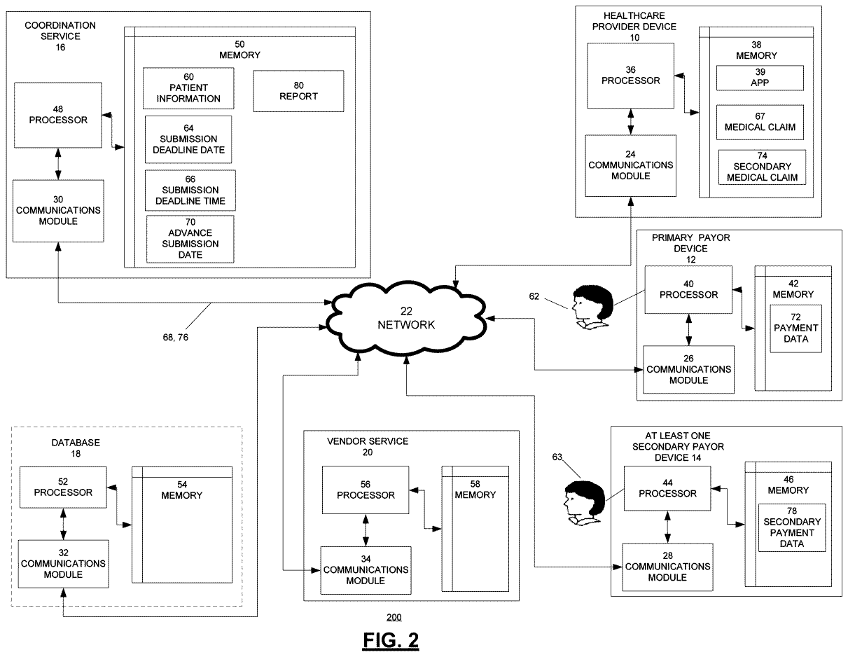

FIG. 2 is a block diagram illustrating examples of the healthcare provider device 10, the primary payor device 12, the at least one secondary payor device 14, the coordination service 16, the database 18, and the vendor service 20 in the architecture of FIG. 1 according to certain aspects of the disclosure.

The healthcare provider device 10, the primary payor device 12, the at least one secondary payor device 14, the coordination service 16, the database 18, and the vendor service 20 are connected over the network 22 via respective communication modules 24, 26, 28, 30, 32, 34. The communication modules 24, 26, 28, 30, 32, 34 are configured to interface with the network 22 to send and receive information, such as data, requests, responses, and commands to/from other devices on the network 22. The communications modules 24, 26, 28, 30, 32, 34 can be, for example, modems or Ethernet cards.

The healthcare provider device 10 includes a processor 36, the communications module 24, and a memory 38 that includes an app 39. The processor 36 of the healthcare provider device 10 is configured to execute instructions, such as instructions physically coded into the processor 36, instructions received from software in the memory 38, or a combination of both. In certain aspects, the app 39 is configured to send and receive information, such as data, requests, responses, and commands to/from the coordination service 16.

The primary payor device 12 includes a processor 40, the communications module 26, and a memory 42. The processor 40 of the primary payor device 12 is configured to execute instructions, such as instructions physically coded into the processor 40, instructions received from software in the memory 42, or a combination of both.

The at least one secondary payor device 14 includes a processor 44, the communications module 28, and a memory 46. The processor 44 of the at least one secondary payor device 14 is configured to execute instructions, such as instructions physically coded into the processor 44, instructions received from software in the memory 46, or a combination of both.

The coordination service 16 includes a processor 48, the communications module 30, and a memory 50. The processor 48 of the coordination service 16 is configured to execute instructions, such as instructions physically coded into the processor 48, instructions received from software in the memory 50, or a combination of both.

The database 18 includes a processor 52, the communications module 32, and a memory 54. The processor 52 of the database 18 is configured to execute instructions, such as instructions physically coded into the processor 52, instructions received from software in the memory 54, or a combination of both.

The vendor service 20 includes a processor 56, the communications module 34, and a memory 58. The processor 56 of the vendor service 20 is configured to execute instructions, such as instructions physically coded into the processor 56, instructions received from software in the memory 58, or a combination of both.

In certain aspects, the disclosed technology monitors electronic interactions between healthcare provider device(s) and primary payor devices, as well as secondary payor device(s), and dates associated with submission deadlines based on guidelines of the primary payor and secondary payor(s), and transmits alerts to the healthcare provider device(s) based on the monitoring of the dates.

During patient intake by a healthcare provider, the healthcare provider device 10 is configured, via the app 39, to receive patient information 60 including, but not limited to, patient name, patient address, patient phone number, payor information associated with the patient (e.g., payor name, payor address, payor telephone number, payor type, payor policy terms, dates for submission deadlines, and other appropriate payor information), whether healthcare that the patient is seeking is related to a motor vehicle accident, whether the patient or a vehicle the patient occupied was covered by a payor, such as an automobile insurance policy, and other appropriate patient information. The patient information 60 received by the healthcare provider device 10 can be transmitted, via the app 39, to the coordination service 16, and can be stored in the memory 50 of the coordination service 16, the memory 54 of the database 18, or a combination of both.

Based on the patient information 60 indicating that the patient was involved in a motor vehicle accident, the healthcare provider associated with the healthcare provider device 10 will then initially seek reimbursement for their services from a primary payor associated with the primary payor device 12, such as, but not limited to, an automobile insurer, under its automobile insurance policy, which may include, but not limited to, medical payment coverage (Medpay), personal injury protection (PIP) coverage, and other appropriate policy coverage. Responsive to receiving the patient information 60, via the app 39, the processor 48 of the coordination service 16 is configured to determine a primary payor 62 from the patient information 60, such as from the payor information. The healthcare provider initially seeks reimbursement from the primary payor first because the primary payor generally pay at a better rate for the healthcare provider. Often times, the primary payor is identified as an automobile insurer. In addition to determining the primary payor 62, the processor 48 of the coordination service 16 is configured to determine at least one secondary payor 63 associated with the at least one secondary payor device 14 from the patient information 60, such as from the payor information.

The processor 48 of the coordination service 16 is configured to determine from the patient information (e.g., the payor information) submission deadline dates and times, and assign a corresponding submission deadline date 64 and submission deadline time 66 to each of the primary payor and the at least one secondary payor that were determined. With the primary payor determined, the processor 48 of the coordination service 16 is configured to transmit a medical claim 67 to the primary payor device 12 associated with the primary payor. In certain aspects, instead of transmitting the medical claim 67 to the primary payor device 12, the processor 48 of the coordination service 16 is configured to transmit a submit claim alert 68 to the app 39 on the healthcare provider device 10 or servicer alerting the healthcare provider associated with the healthcare provider device 10 to submit a payment request (e.g., the medical claim 67) to the primary payor in a usual manner.

The processor 48 of the coordination service 16 is configured to, based on the type of payor identified in the payor information of the patient information 60, determine and assign an advance submission date 70 to each of the secondary payors determined from the at least one secondary payor associated with each corresponding at least one secondary payor device 14. The advance submission date 70 is a time period in advance of the submission deadline date 64, which can be a default calculation based on the type of payor, can be customized by a user on the healthcare provider device 10 via the app 39, or can be customized based on policy terms of the secondary payor. For example, private health insurers typically contain a ninety (90) day submission deadline from the date of service for consideration of payment in their policies. Thus, an advance submission date 70 is set for sixty (60) days (or a customized advance submission date 70 a provider chooses that is advance of the submission deadline date 64) from the date of service for that payor. As another example, public health insurer payors, including but not limited to, Medicare, Medicare type plans (e.g. Medicare advantage plans, Medicare MCOs), Medicaid, Medicaid type plans (e.g. Medicaid advantage plans, Medicaid MCOs), and other appropriate public health insurer payors, generally carry a 365 day submission deadline (see 42 C.F.R. § 424.44(a)(1) as it pertains to Medicare), such that they would be assigned an advance submission date 70 for 335 days from the date of service (or a customized advance submission date 70 a provider chooses that is in advance of the 365 day submission deadline).

After the medical claim 67 is transmitted to the primary payor device 12 associated with the primary payor, or after the medical claim 67 is submitted by the healthcare provider associated with the healthcare provider device 10 to the primary payor, the coordination service 16 is configured to monitor the healthcare provider device 10, via the app 39, for payment data 72 related to the medical claim 67, which may be received by the healthcare provider device 10 from the primary payor device 12. The payment data 72 includes information such as, but not limited to, payment amount received, payment date received, balance amount remaining, and other appropriate payment information. In certain aspects, the healthcare provider device 10 receives the payment data 72 (e.g., 835 data, Electronic Remittance Advice, and other electronic transaction payment data) from the primary payor device 12 and can then be transmitted to the coordination service 16 via the app 39. In other aspects, the payment data 72 maybe received manually by the healthcare provider associated with the healthcare provider device 10 from the primary provider associated with the primary provider device 12, in which case, the healthcare provider device 10 will receive the payment data 72 via a user manually inputting the payment data 72.

With the medical claim 67 transmitted or submitted to the primary payor associated with the primary payor device 12, the coordination service 16 monitors each advance submission date 70 previously assigned to the at least one secondary payor associated with the at least one secondary payor device 14 that were determined. The processor 48 of the coordination service 16 is configured to identify when the advance submission date 70 occurs and, based on identifying the advance submission date 70 occurring, determine from the payment data 72 any balance amount remaining on the medical claim 67.

In certain aspects, when it determines that there is a balance amount remaining on the medical claim 67, the processor 48 of the coordination service 16 is configured to transmit a secondary medical claim 74, including the balance amount remaining on the medical claim 67, to the at least one secondary payor device 14 associated with the at least one secondary primary payor. In certain aspects, instead of transmitting the secondary medical claim 74 to the at least one secondary payor device 14, the processor 48 of the coordination service 16 is configured to transmit a submit secondary claim alert 76 to the app 39 on the healthcare provider device 10 or servicer alerting the healthcare provider associated with the healthcare provider device 10 to submit a secondary payment request (e.g., the secondary medical claim 74) to the at least one secondary payor in a usual manner.

In certain aspects, the healthcare provider device 10 receives secondary payment data 78 (e.g., 837 data, Electronic Remittance Advice, and other electronic transaction payment data) from the at least one secondary payor device 14 and can then be transmitted to the coordination service 16 via the app 39. In other aspects, the secondary payment data 78 maybe received manually by the healthcare provider associated with the healthcare provider device 10 from the at least one secondary provider associated with the at least one secondary provider device 14, in which case, the healthcare provider device 10 will receive the secondary payment data 78 via a user manually inputting the secondary payment data 78. The secondary payment data 78 includes information such as, but not limited to, payment amount received, payment date received, balance amount remaining, identity of the payor, any adjustment amounts, and other appropriate payment information.

With the secondary medical claim 74 transmitted or submitted to the at least one secondary payor associated with the at least one secondary payor device 14, the coordination service 16 monitors each advance submission date 70 previously assigned to the at least one secondary payor associated with the at least one secondary payor device 14 that were determined. The processor 48 of the coordination service 16 is configured to identify when the advance submission date 70 occurs and, based on identifying the advance submission date 70 occurring, determine from the secondary payment data 78 any balance amount remaining on the secondary medical claim 74. In a similar manner as described above, the coordination service 16 will either transmit a subsequent medical claim to the next identified payor from the at least one secondary payor that was determined or alert the healthcare provider device 10 to submit payment. The processor 48 of the coordination service 16 is configured to repeat such process for any other remaining payors from the at least one secondary payor that was determined until all potential payors are exhausted. When all potential payors are exhausted, the processor 48 of the coordination service 16 generates a report 80 including, but not limited to, payment information received from all providers indicating for each payment received the amount of payment, any adjustment amount, the identity of the payor, the date of receipt of each payment, ending outstanding balance, and other appropriate information, and transmits the report 80 to the healthcare provider device 10 via the app 39. After receiving the report 80, the healthcare provider associated with the healthcare provider device 10 will then be able to use this information in the report 80 to write-off any remaining balance (and be able to report such write-offs for reporting purposes (e.g. for purposes of retaining non-profit status)) or bill the patient for any remaining balance, if appropriate.

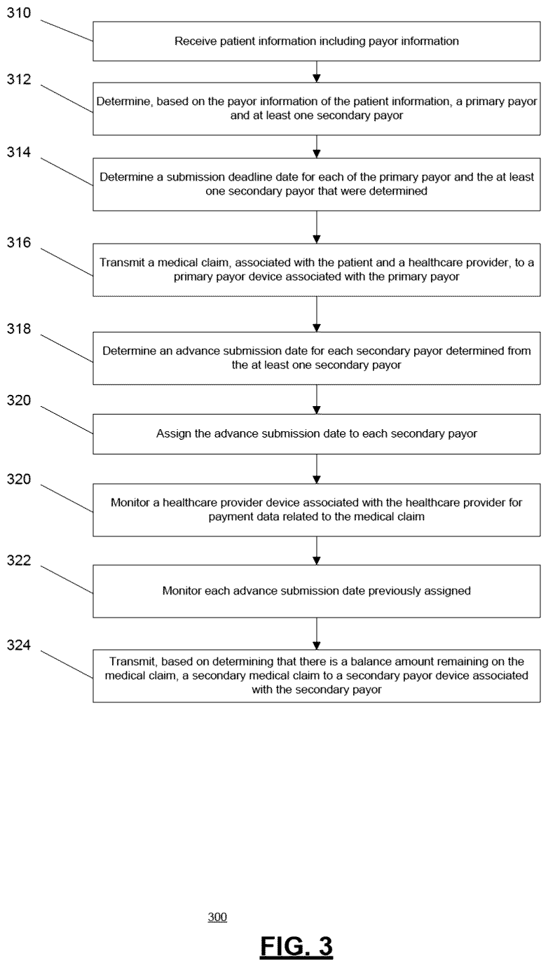

FIG. 3 illustrates an example process 300 using the healthcare provider device 10, the primary payor device 12, the at least one secondary payor device 14, the coordination service 16, the vendor service 20, and, in certain aspects, the database 18. While FIG. 3 is described with reference to FIG. 2, it should be understood that the process steps of FIG. 3 may be performed by other systems.

In certain aspects, the process 300 begins by proceeding to step 310, during patient intake by a healthcare provider, when the coordination service 16, via the app 39 on the healthcare provider device 10, receives patient information 60 including payor information associated with the patient. As depicted at step 312, based on the patient information 60, the coordination service 16 determines a primary payor 62 and at least one secondary payor 63. The coordination service 16 determines a submission deadline date 64 for each of the primary payor 62 and the at least one secondary payor 63 that were determined, as illustrated at step 314. With the primary payor 62 determined, the processor 48 of the coordination service 16 transmits a medical claim 67, associated with the patient and the healthcare provider, to the primary payor device 12 associated with the primary payor 62, as depicted at step 316.

As illustrated at step 318, the processor 48 of the coordination service 16 determines an advance submission date 70 for each secondary payor determined from the at least one secondary payor. The processor 48 of the coordination service 16 assigns the advance submission date 70 to each secondary payor determined, as depicted at step 318. After the medical claim 67 is transmitted to the primary payor device 12 associated with the primary payor 62, or after the medical claim 67 is submitted by the healthcare provider associated with the healthcare provider device 10 to the primary payor 62, the coordination service 16 monitors the healthcare provider device 10, via the app 39, for payment data 72 related to the medical claim 67, which may be received by the healthcare provider device 10 from the primary payor device 12, as depicted at step 320.

With the medical claim 67 transmitted, or submitted to the primary payor 62 associated with the primary payor device 12, the coordination service 16 monitors each advance submission date 70 previously assigned, as illustrated at step 322. Based on determining that there is a balance amount remaining on the medical claim 67, the processor 48 of the coordination service 16 transmits a secondary medical claim 74 to a secondary payor device assigned to the advance submission date 70, as depicted at step 324. In other aspects, instead, the processor 48 of the coordination service 16 transmits a submit secondary claim alert 76 to the app 39 on the healthcare provider device 10 alerting the healthcare provider associated with the healthcare provider device 10 to submit a secondary payment request.

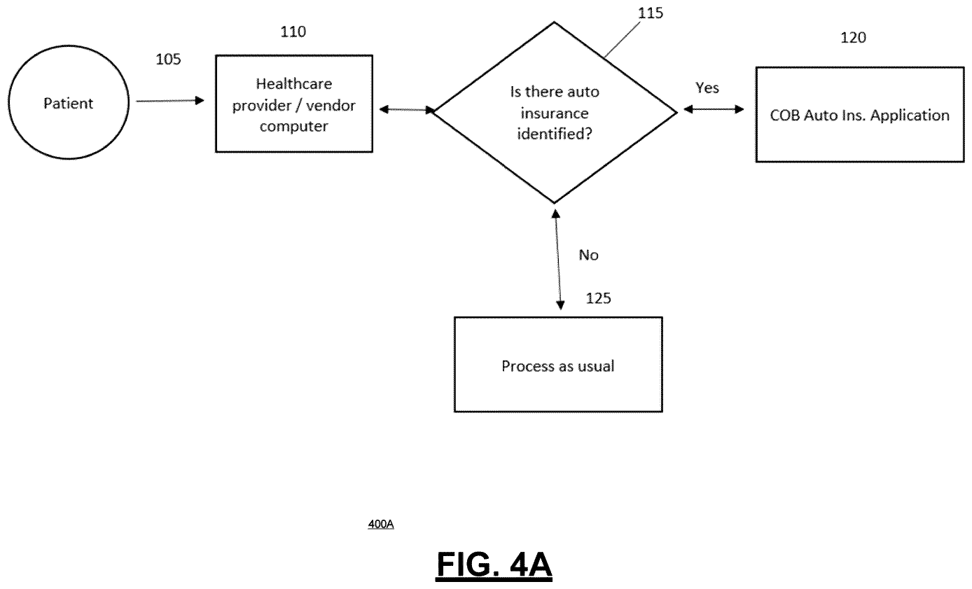

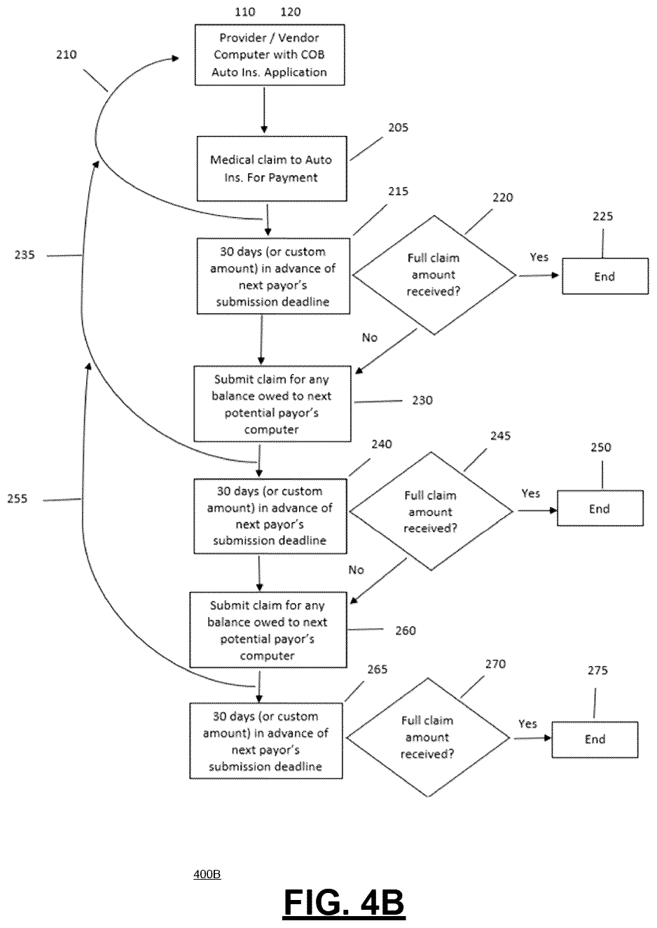

FIGS. 4A and 4B illustrate example processes 400A and 400B, according to certain aspects, using the healthcare provider device 10, the primary payor device 12, the at least one secondary payor device 14, the coordination service 16, the vendor service 20, and, in certain aspects, the database 18. While FIGS. 4A and 4B is described with reference to FIG. 2, it should be understood that the process steps of FIGS. 4A and 4B may be performed by other systems.

As shown in FIG. 4A, the process 400A begins with a patient providing potential payor information 105 which is then input and recorded in the provider computer 110 which then may also be transferred to a service provider computer. The system then identifies whether an automobile insurer was identified as a potential payor for the claim 115. In the event no automobile insurance is identified as a potential payor, the claim is processed as it typically would be by the provider when there is no automobile insurance identified as a potential payor 125. In the event automobile insurance is identified as a potential payor, the system alerts the provider computer to process the claim with the automobile insurer as the primary payor 120.

Referring to FIG. 4B, the process 400B illustrates coordinating benefits in healthcare claim transactions involving automobile insurance as a potential payor.

As stated, once the automobile insurance payor information is input for a patient in the provider's computer, the system assigns all other potential secondary payors a submission deadline date and an advanced notice date as set forth above 215, 240. The provider computer and system (or service computer) then submits claim payment data to the automobile insurer computer for processing and payment 205. Upon receiving any payments from the automobile insurer, including through 835 data transmitted and received from any automobile insurer's computer, that data is transmitted to the provider's computer 210 and is recorded 110, including the amount paid, date received by the provider, the identity of the payor, any adjustments, and any balance.

Upon reaching the next payor's advanced submission deadline 215, the provider's computer determines whether there is any remaining balance outstanding on the claim based on the previous data received, or lack thereof, from the automobile insurer 220. If there is no balance remaining, there is no further action taken 225. If there is any balance remaining, the provider's computer automatically submits claim payment data for the remaining balance to that secondary payor's computer for processing 230 or provides the provider with a notice of that submission deadline for purposes of manual submission. Once payment is issued by the secondary payor, the secondary payor submits data back to the provider computer 235, 110 regarding that payment including through 835 data. That payment information is then recorded and saved by the provider computer 110, including the amount of the payment, any adjustment amount, the identity of the payor, the date received, and any remaining balance based on any previous data recorded and saved pertaining to any previous payments received on that claim.

The process then repeats as to any remaining potential payors in the event there is any remaining balance left on the claim until all potential payors have been exhausted or no remaining balance remains on the claim 240, 245, 250, 255, 260, 265, 270, 275. Upon completion, the provider is notified of any balance remaining for purposes of recording and reporting as a write-off or submitting to the patient for payment if deemed appropriate by the provider.

The following is a real-world example (the actual identities of the parties are being omitted). In March of 2023, a patient was injured in a motor vehicle collision and received medical care at a prominent health care provider based out of Ohio for her injuries. The patient was insured by a Medicaid MCO policy at the time of her care. The provider, presumably believing that the patient's own automobile insurer had MedPay coverage available or that the at fault driver's automobile insurer would cover the bill, failed to submit its bill to the health insurer for its over $10,000.00 bill. Later on, the provider attempted to collect its full billed amount from the patient. The provider was sued for violating Ohio R.C. 1751.60 and Ohio Admin. Code 5101:3-1-60(A) for attempting to collect its bill from the patient in lieu of her health insurer, as well as Ohio's Consumer Sales Practices Act. The provider was therefore precluded from collecting any of its bill, as well as subject to statutory monetary penalties as well as the costs associated with litigation including attorney fees and case expenses.

In the foregoing example, the system would have recognized that the full amount of the claim was outstanding within the time permitted to submit its bill to the Medicaid MCO, and would have automatically submitted the appropriate claim data associated with the full amount of the bill outstanding to the Medicaid MCO to allow processing and payment. In the end, the system would have caused the provider to receive payment in accordance with the Medicaid reimbursement rate for its $10,000.00 bill in lieu of losing the reimbursement rate amount for its bill as well as the costs and expense associated with its legal liability.

In another example, a patient presents to a provider for injuries sustained in a motor vehicle accident, and provides his automobile insurance and private health insurance information. Upon inputting the patient's auto insurance, the system would automatically recognize an automobile insurer and automatically assign a submission deadline of 60 days from the date of service for the other private insurer. The provider submits its bill for $5,000.00 to the patient's auto insurer, who pays $1,000.00 due to other providers having already exhausted all other Medpay coverage under the patient's automobile insurance policy. On the 60th day after the date of service the system recognizes a payment received of $1,000.00 from the automobile insurer and a balance of $4,000.00 outstanding. The system would then submit a medical claim for the remaining $4,000.00 on the 60th day from the date of service to the private health insurer's computer for payment and processing.

In a third example, a patient presents to the provider for injuries sustained in a motor vehicle accident, and provides his automobile insurance information and his Medicare MCO information. The provider submits a bill for $10,000.00 to the automobile insurer. However, due to a lapse in coverage, there are no payments received from the auto insurer. On the 335th day from the date of service, the system automatically sends a medical claim for $10,000.00 to the Medicare MCO's computer and, optionally, sending a notice/alert to the provider. This allows the provider to receive payment in accordance with the Medicare reimbursement rate while also avoiding any risk of legal liability for improper billing practices.

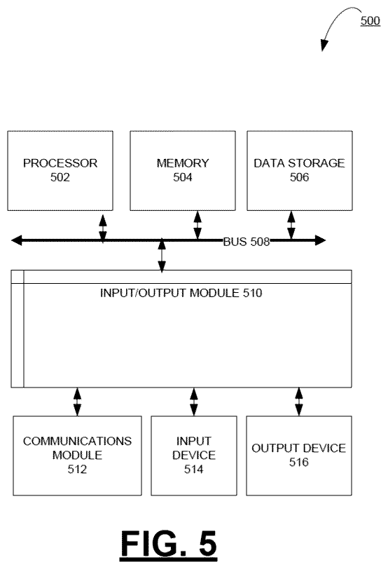

FIG. 5 is a block diagram illustrating an example computer system 500 with which the healthcare provider device 10, the primary payor device 12, the at least one secondary payor device 14, the coordination service 16, the database 18, and the vendor service 20 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., the healthcare provider device 10, the primary payor device 12, the at least one secondary payor device 14, the coordination service 16, the database 18, and the vendor service 20) includes a bus 508 or other communication mechanism for communicating information, and a processor 502 (e.g., the processor 36, 40, 44, 48, 52, 56) coupled with bus 508 for processing information. According to one aspect, the computer system 500 can be a cloud computing server of an IaaS that is able to support PaaS and SaaS services.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., the memory 38, 42, 46, 50, 54, 58), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, e.g., one or more modules of computer program instructions encoded on a computer readable medium for execution by, or to control the operation of, the computer system 500.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. Example communications modules 512 (e.g., the communications module 24, 26, 28, 30, 32, 34) include networking interface cards, such as Ethernet cards and modems.

In certain aspects, the input/output module 510 is configured to connect to a plurality of devices, such as an input device 514 and/or an output device 516. Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device.

According to one aspect of the present disclosure the healthcare provider device 10, the primary payor device 12, the at least one secondary payor device 14, the coordination service 16, the database 18, and the vendor service 20 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for monitoring and notifying a healthcare provider device, the computer-implemented method comprising:
receiving patient information of a patient including payor information;
determining, based on the payor information of the patient information, a primary payor and at least one secondary payor;
determining a submission deadline date for each of the primary payor and the at least one secondary payor that were determined;
transmitting a medical claim, associated with the patient and a healthcare provider, to a primary payor device associated with the primary payor;
determining an advance submission date for each secondary payor determined from the at least one secondary payor;
assigning each corresponding advance submission date to each secondary payor;
monitoring a healthcare provider device associated with the healthcare provider for payment data related to the medical claim;
monitoring each advance submission date previously assigned to each secondary payor; and
transmitting, based on determining, from the payment data monitored, that there is a balance amount remaining on the medical claim, a secondary medical claim to a secondary payor device associated with the secondary payor on an advance submission date assigned to the secondary payor.

2. The computer-implemented method of claim 1, further comprising:
monitoring the healthcare provider device for secondary payment data;
determining, based on the secondary payment data being monitored, any balance amount remaining on the secondary medical claim; and
transmitting, based on determining a balance amount remaining on the secondary medical claim, a subsequent medical claim to a next identified secondary payor device associated with a next identified secondary payor of the at least one secondary payor.

3. The computer-implemented method of claim 2, further comprising:
generating a report comprising at least payment information received.

4. The computer-implemented method of claim 3, further comprising:
determining, based on the payment information received in the report, a remaining balance.

5. The computer-implemented method of claim 4, further comprising:
notifying the healthcare provider of the remaining balance.

6. The computer-implemented method of claim 1, wherein the primary payor is an automobile insurer.

7. The computer-implemented method of claim 1, further comprising:
storing the patient information in a database.

8. A system comprising:
a memory comprising instructions; and
a processor configured to execute the instructions which, when executed, cause the processor to:
receive patient information of a patient including payor information;
determine, based on the payor information of the patient information, a primary payor and at least one secondary payor;
determine a submission deadline date for each of the primary payor and the at least one secondary payor that were determined;
transmit a medical claim, associated with the patient and a healthcare provider, to a primary payor device associated with the primary payor;
determine an advance submission date for each secondary payor determined from the at least one secondary payor;
assign each advance submission date to each secondary payor;
monitor a healthcare provider device associated with the healthcare provider for payment data related to the medical claim;
monitor each advance submission date previously assigned to each secondary payor; and
transmit, based on determining, from the payment data monitored, that there is a balance amount remaining on the medical claim, a secondary medical claim to a secondary payor device associated with the secondary payor on an advance submission date assigned to the secondary payor.

9. The system of claim 8, wherein the processor is further configured to execute the instructions which, when executed, cause the processor to:
monitor the healthcare provider device for secondary payment data;
determine, based on the secondary payment data being monitored, any balance amount remaining on the secondary medical claim; and
transmit, based on determining a balance amount remaining on the secondary medical claim, a subsequent medical claim to a next identified secondary payor device associated with a next identified secondary payor of the at least one secondary payor.

10. The system of claim 9, wherein the processor is further configured to execute the instructions which, when executed, cause the processor to:
generate a report comprising at least payment information received.

11. The system of claim 10, wherein the processor is further configured to execute the instructions which, when executed, cause the processor to:
determine, based on the payment information received in the report, a remaining balance.

12. The system of claim 11, wherein the processor is further configured to execute the instructions which, when executed, cause the processor to:
notify the healthcare provider of the remaining balance.

13. The system of claim 1, wherein the primary payor is an automobile insurer.

14. The system of claim 1, wherein the processor is further configured to execute the instructions which, when executed, cause the processor to:
store the patient information in a database.

15. A non-transitory machine-readable storage medium comprising machine-readable instructions for causing one or more processors to execute a method, the method comprising:
receiving patient information of a patient including payor information;
determining, based on the payor information of the patient information, a primary payor and at least one secondary payor;
determining a submission deadline date for each of the primary payor and the at least one secondary payor that were determined;
transmitting a medical claim, associated with the patient and a healthcare provider, to a primary payor device associated with the primary payor;
determining an advance submission date for each secondary payor determined from the at least one secondary payor;
assigning each corresponding advance submission date to each secondary payor;
monitoring a healthcare provider device associated with the healthcare provider for payment data related to the medical claim;
monitoring each advance submission date previously assigned to each secondary payor; and
transmitting, based on determining, from the payment data monitored, that there is a balance amount remaining on the medical claim, a secondary medical claim to a secondary payor device associated with the secondary payor on an advance submission date assigned to the secondary payor.

16. The non-transitory machine-readable storage medium of claim 15, wherein the method further comprises
monitoring the healthcare provider device for secondary payment data;
determining, based on the secondary payment data being monitored, any balance amount remaining on the secondary medical claim; and
transmitting, based on determining a balance amount remaining on the secondary medical claim, a subsequent medical claim to a next identified secondary payor device associated with a next identified secondary payor of the at least one secondary payor.

17. The non-transitory machine-readable storage medium of claim 16, wherein the method further comprises generating a report comprising at least payment information received.

18. The non-transitory machine-readable storage medium of claim 17, wherein the method further comprises determining, based on the payment information received in the report, a remaining balance.

19. The non-transitory machine-readable storage medium of claim 18, wherein the method further comprises notifying the healthcare provider of the remaining balance.

20. The non-transitory machine-readable storage medium of claim 15, wherein the primary payor is an automobile insurer.
